(19) United States
(12) Patent Application Publication
(10) Pub. No.: US 2003/0064812 A1
(43) Pub. Date: Apr. 3, 2003

(54) Smart card enhanced toys and games

(76) Inventors: Ethan Rappaport, Orange, CT (US); Arthur Swanberg, Westport, CT (US)

Correspondence Address: Drinker Biddle & Reath, LLP, One Logan Square, 18th and Cherry Sts., Philadelphia, PA, 19103-6996, US

(21) Appl. No.: 09/969,953

(22) Filed: Oct. 2, 2001

(51) Int. Cl. A63F 9/24; A63F 13/00; G06F 17/00; G06F 19/00

(52) U.S. Cl. 463/43

(57) ABSTRACT

A toy such as a talking doll or a random outcome generator for board games selects at random one of a repertoire of outputs. The outputs may be read from a smart card, or from an internal memory that was previously loaded from a smart card. Preferably, the toy is under control of a microprocessor embedded in the smart card. A portable educational or game-playing device presents information and prompts to a user using stored data, and receives the user's responses. A new repertoire of outputs may be downloaded onto the smart card over the internet. For game-playing, education, or other structured activities, the portable device records the user's progress onto the smart card. The network server then downloads only data appropriate for the next stage of education or game-play.

### FIELD OF THE INVENTION

The invention relates to toys, games, and other recreational devices, including board games, dolls, educational toys, and the like. The invention relates in particular to toys with behaviors generated by an electronic component using stored data.

### BACKGROUND OF THE INVENTION

The use of electrical or mechanical devices to enhance toys and games is well known. For example, a child's doll may be equipped with a sound-reproducing device that will play one of a range of recorded speeches, or a board game requiring an element of chance may be provided with an electrical random number generator instead of conventional manual dice. However, in the past the content of such devices has been fixed, or has been capable of being changed only by procuring a new data or program storage element containing new content.

Electronic games are known in which a player, interacting with a game device, may assume a role of a character, and may acquire equipment or other attributes that can affect the player's success in the game. However, if a player's character was to be maintained from one playing session to another, such games have hitherto required a data file to be maintained within the game device recording the attributes of the character. This has the disadvantages that a character exists only on the individual game device, and cannot, or cannot easily, be ported to another device running the same game, and that procedures for resuming a game in a new session with existing characters tend to be cumbersome or inflexible.

It is known for educational purposes to present a student with information, prompt the student to answer questions or do exercises related to that information, assess the user's grasp of the information from the responses to the questions, and select further information and/or prompts in dependence on the assessment. However, such a procedure usually requires the involvement of a human instructor, at least for the assessment and selection.

Educational toys and devices that mechanically present questions to a student and indicate whether the answers are correct are known. Such devices could be used independently by a student without supervision by a human instructor. However, in the past the content of such devices has been fixed, or has been capable of being changed only by procuring a new data storage element containing new content. Further, where new data storage elements were available the decision to procure new data was made by the student. As a result, such devices are conventionally limited to presenting a fixed set of data, and do not provide any form of interactive assessment or instruction. Where multiple sets of data are available, there is no assurance that a student will master one set before attempting a second set that relies on knowledge of the first set. Nor is there any assurance that a student will not repeat the questions in the first set unnecessarily after he or she has effectively mastered them. The practicalities of distributing new data storage elements mean that only a limited number of distinct sets of content are available. Such devices are never the less useful, for example, in certain aspects of language teaching, where the material presented is conceptually simple, and repetitive exercises are helpful.

Computer-based interactive teaching programs have been proposed. However, the level of processing power and data storage required for serious interactive teaching requires the use of a computer that is large, expensive, and inconvenient. To use such programs, the user must be either at a computer terminal or using a device in constant communication with a computer.

### SUMMARY OF THE INVENTION

The current invention discloses methods and apparatus for transferring data or functionality in electronic form to portable educational devices and other toys by means of smart cards, in order to provide new behaviors: A smart card is a card capable of storing data and transmitting stored data, and especially a card with at least limited processing capability on the card. This is typically achieved with an embedded chip storing data in electronic form, although other storage systems can be used on the cards.

In one aspect of the invention, there is provided a recreational device comprising a smart card, a smart-card writer adapted to be connected to a network and to record on said smart card information received over said network, and a portable device. The portable device comprises a control operable by a user, a signaling unit adapted to produce outputs perceptible by the user, and a smart-card reader adapted to receive a smart card and to read information determining said outputs from said smart card. A controller is adapted to cause the signaling unit to produce a selected one of a plurality of outputs in response to operation of the control. The controller may be a processor forming part of the portable device, or may be a processor in the smart card.

In another aspect of the invention, there is provided such a portable device that comprises a control operable by a user, an output device adapted to produce outputs perceptible by the user, and a smart-card reader adapted to receive a smart card and to read information from said smart card. The portable device may further include a controller responsive to operation of the control to cause the output device to produce a selected one of a plurality of outputs using the information read from the smart card, or may be designed to use a controller on the smart card.

The control may be a simple actuation control, and the selection of the output to be produced may be random. Instead, the control may allow a user-selected input and the output may then be at least partly dependent on the input.

In another aspect of the invention, there is provided a method of using a recreational device. In this method, a portable device is provided that is capable of displaying various behaviors using stored data, and is equipped with a smart card reader capable of reading such data from a smart card. A smart card capable of storing and transmitting electronic data, a server carrying such data and accessible over a network, and a smart card reader/writer capable of writing said data onto the smart card are provided. The user inserts the smart card into the reader/writer. A communication link is established between the reader/writer and the smart card. The user selects data for transmission from the server to the smart card. The selected data is read from the server, transmitted to the smart card, and written onto the smart card. The user then removes the smart card from the reader/writer and inserts it into the reader in the portable device. The portable device then reads the selected data from the smart card, and is operated to display its new behaviors using the selected data.

In another aspect of the invention, there is provided a method of playing a game. A player inserts into a game-playing device a smart card, on which is stored information denoting a status of the player within the game. At the end of the playing session, updated status information is stored on the smart card, which is retained by the player. The player can then play further sessions of the game on any similar device programmed to play that game, beginning each session with the status saved at the end of the previous session.

According to a further aspect of the invention, there is provided an educational device comprising a smart card, a smart-card writer adapted to be connected to a network, and to record on said smart card information received over said network, and a portable device. According to another aspect of the invention, there is provided such a portable device. In either aspect, the portable device comprises an output device adapted to produce outputs perceptible by the user, an input device adapted to receive input from the user, and a smart-card reader adapted to receive a smart card, to read from said smart card, and to write to said smart card. A controller adapted to cause the output device to display information and prompts to the user using stored data, to receive inputs from the user in responsive to such prompts, and to record on the smart card status information relating to such responses, is provided either in the portable device or on the smart card.

According to a further aspect of the invention, there is provided a method of education using such a portable device. Information and prompts are presented to a user by means of said portable device using said stored data. The portable device accepts inputs from a user responsive to such prompts, records status information related to the responsive inputs, and determines from the status information when new stored data is to be procured. A smart card capable of storing and transmitting electronic data, a server carrying such data and accessible over a network, and a smart card reader/writer capable of writing said data onto said smart card are provided. The smart card is then inserted into the reader/writer, a communication link is established between the reader/writer and the server, and status data previously written to the smart card by the portable device is transmitted to the server. Data is selected and transmitted from the server to the smart card in response to the transmitted status data. The smart card is then removed from the reader/writer and inserted into the reader of the portable device, the selected data is read from the smart card, and the portable device is operated using the selected data.

With the method and devices of the invention, it is possible to provide on a small, cheap, portable device a level of educational functionality that would otherwise require high levels of processing power and storage capacity, either locally or through a network connection. The portable device of the invention requires only a display, a keypad or other input device, a smart card reader/writer and a processor. Because of the use of a smart card, loading new data can be made exceptionally simple for the user. The smart card reader/writer can be permanently attached to a networked computer, so that after the initial installation the user never needs to become entangled with the cabling that is found behind a typical personal computer.

### BRIEF DESCRIPTION OF THE DRAWINGS

For the purpose of illustrating the invention, there are shown in the drawings embodiments of the invention which are presently preferred; it being understood, however, that this invention is not limited to the precise arrangements and instrumentalities shown. In the drawings:

FIG. 1 is a schematic of one embodiment of the invention, including a portable device in the form of a doll.

FIG. 2 is an enlarged schematic of a doll shown in FIG. 1.

FIG. 3 is an enlarged schematic of a smart card shown in FIG. 1.

FIG. 4 is a perspective view of a board game and a portable device in the form of an electronic dice forming part of a second embodiment of the invention.

FIG. 5 is a perspective view of a game device forming part of a third embodiment of the invention.

FIG. 6 is a a block diagram of a portable educational toy forming part of a fourth embodiment of the invention.

FIG. 7 is a flow chart showing one aspect of the method of the current invention.

FIG. 8 is a flow chart showing another aspect of the method of the invention.

FIG. 9 is a flow chart showing a further aspect of the method of the invention.

FIG. 10 is a flow chart showing another aspect of the method of the invention.

### DETAILED DESCRIPTION OF THE DRAWINGS

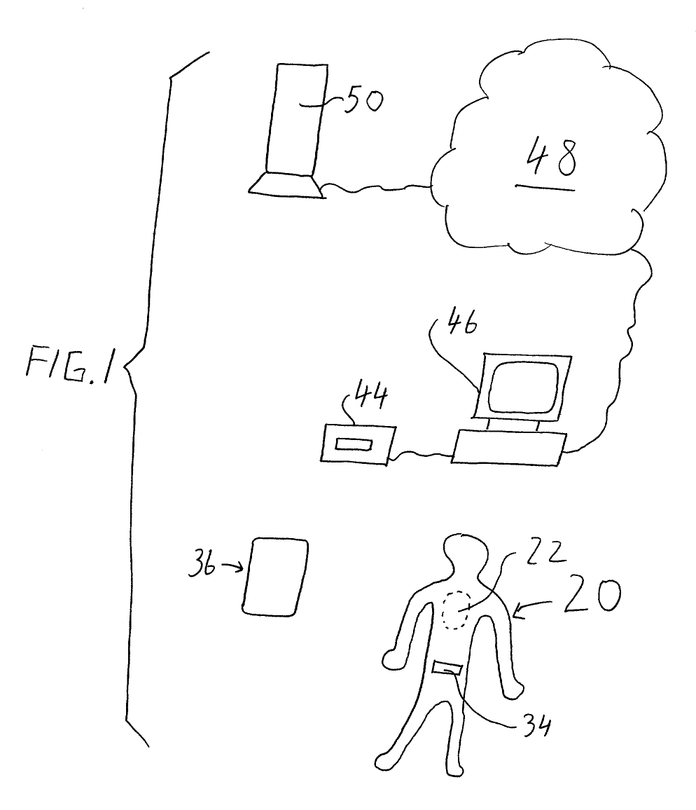

Referring to the drawings, and initially to FIGS. 1 to 3, a recreational device or toy 20, in the form of a doll, includes an electronic device capable of generating various behaviors, in the form of a sound reproducing unit 22 that is capable of generating one of a set of pre-recorded speeches. The sound reproducing unit 22 comprises a loudspeaker 24 driven by a controller, which may be in the form of a microprocessor 26, and may also include a storage device 28 for the doll's speeches, which may be in the form of one or more memory chips. The controller 26 is connected to a sensor 32, which detects when the doll 20 is squeezed or manipulated in some other particular way. A power supply 30, which may be in the form of replaceable or rechargeable batteries, is provided to power the sound reproducing unit.

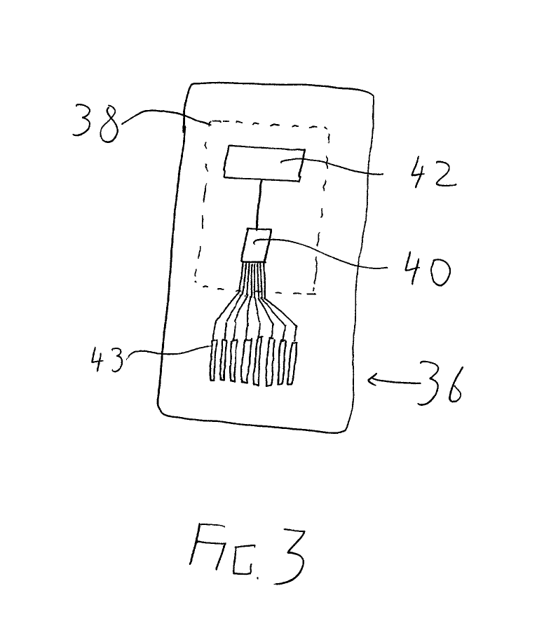

The doll 20 is equipped with a reader 34 for a smart card 36. The smart card 36 has one or more embedded chips 38. The smart card 36 may be a microprocessor card containing an embedded microprocessor 40, or a memory card containing an embedded memory chip 42. As shown in FIG. 3, the smart card 36 has both a microprocessor 40 and a memory chip 42, for storing and retrieving information, although other storage and retrieval means are possible. The smart card 36 comprises an external connection 43 in the form of an antenna or electrical contacts on the exterior of the card, by which the card can receive power and can receive data from and transmit data to an interface unit.

The doll 20 may be designed to operate with the smart card in the reader, in which case the speeches may be stored in the memory 42 on the smart card. The memory chips 28 may then not be needed. Instead, or in addition, the microprocessor 40 on the smart card 36 may monitor the sensor 32 and control the loudspeaker 24, and the microprocessor 26 may then not be needed. Instead, the doll 20 may be designed to transfer information from the smart card 36 onto the memory 28 within the doll, and the smart card is then removed from the doll and stored separately except when it is actually being used for data transfer. The microprocessor 40 may then be needed only to control the memory 42, and may be a very simple device. In order to maximize the versatility of the doll, it is preferred that the primary processing capability be in the microprocessor chip 40 on the smart card 36 is a programmable computer processor, and the primary processing capability is in the microprocessor chip 40. The behaviors of the doll can then be substantially changed by substituting a different, or differently programmed, smart card 36. However, certain functions that require substantial memory or processing capacity, that do not call for easy reprogramming, and that are easily separable from the main control of the doll, may advantageously reside in a processor 26 and memory 28 in the doll 20. For example, a text-to-speech program or other speech generation procedure may be carried out by the processor 26 and memory 28.

In use, when the sensor 32 detects an appropriate manipulation of the doll 20, the controller 26 or 40 selects at random, or quasi at random, one of the speeches stored in the memory 28 or 42, and plays that speech to the user through the loudspeaker 24. The doll is initially sold with a first set of pre-recorded speeches stored on the memory 28 inside the doll, or with a smart card 36 that has the first set of pre-recorded speeches stored in its memory 42.

The speeches may be in the form of recorded sound, preferably in a compressed format such as MP3, or may be in coded form readable by the controller 26 or 40.

The controller 26 or 40 and the reader 34 may also be capable of writing onto the smart card data identifying the particular model of doll 20 and/or a serial number or the like identifying the individual doll 20. This may require at least a small memory 28 in the doll 20, to contain the serial number or identifying data. That is preferably in the form of ROM, because it should not be changed.

The smart card 36 can also be read, and written to, by a smart card interface unit in the form of a reader/writer 44 attached to a computer 46. The computer 46 is in communication over the internet 48 or other network with a server computer 50. For ease of installation, the card reader/writer 44 is preferably equipped with a plug that will connect to an external data port on a generally available personal computer, and the card reader/writer 44 is equipped to communicate through such data port using an appropriate protocol. Such data ports, plugs, and protocols are well understood by those skilled in the art, and it is within the judgment and ability of the skilled reader to select and implement an appropriate connection.

In order to provide the doll with new behaviors, in the form of a new repertoire of speeches, the smart card 36 may be placed in the reader/writer 44. A user operating the computer 46 then accesses a supporting website based on the server 50, via the internet or other network 48. Such a website may be maintained by the manufacturer or distributor of the dolls 20. The user then selects, from a range available on the website, new speeches either individually or in a bundle, and downloads them onto the smart card 36. In order to ensure that the speeches selected are appropriate to the style of doll, and are within the technical capabilities of the doll, the user may be asked to specify the type of doll, or to provide an identifying number for an individual doll. The user's selection may then be restricted accordingly. Instead, or in addition, the reader/writer 44 may read from the smart card 36 information identifying the doll or type of doll, and the user's selections may then be guided automatically.

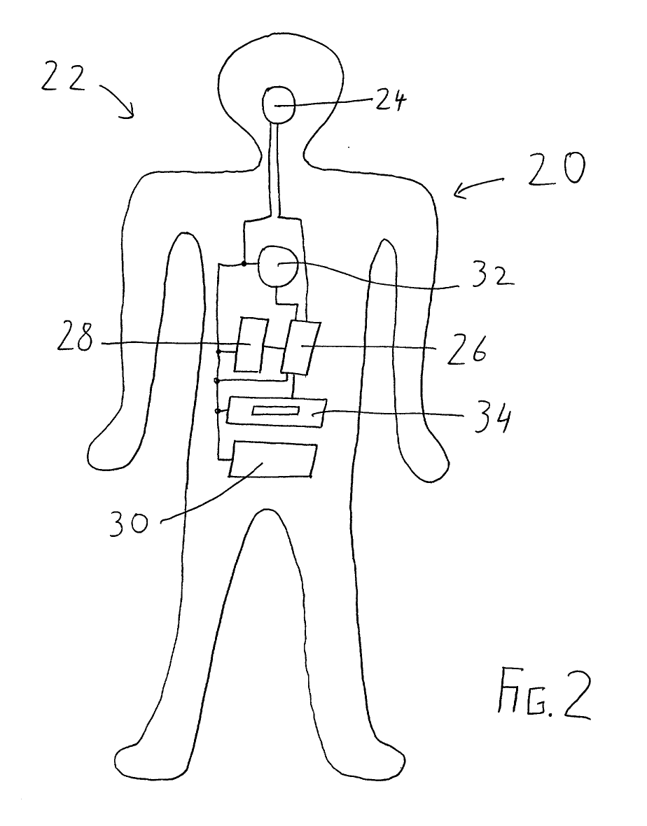

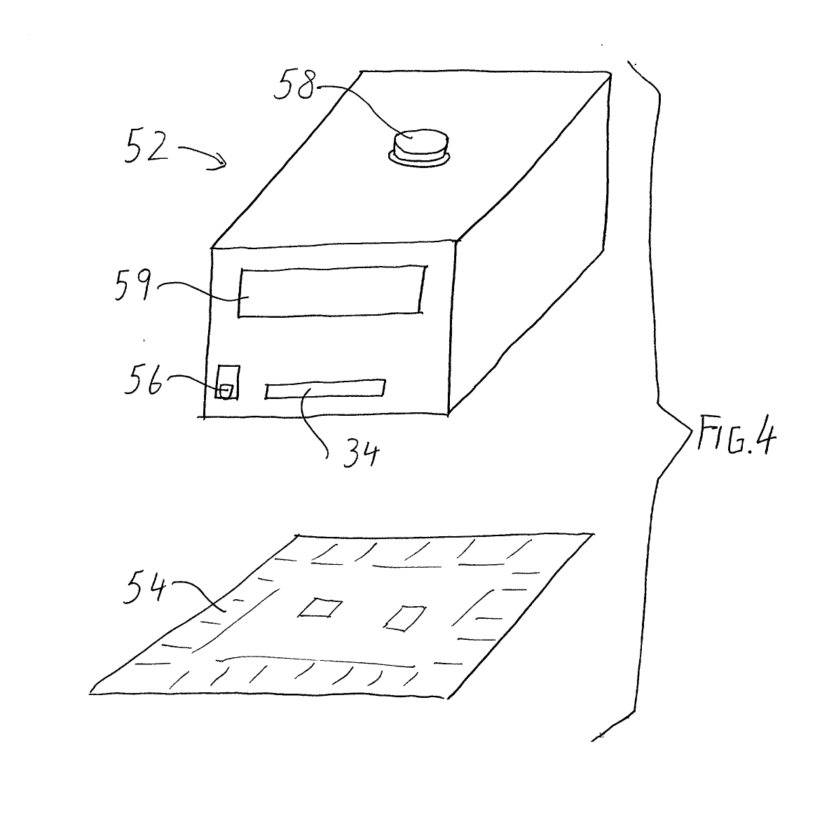

Referring now to FIG. 4, a second form of recreational device according to the invention comprises a pocket reader or “electronic dice” 52 accompanying a board game 54. The pocket reader 52 comprises a controller 26, memory 28, and a power supply 30, as shown in FIG. 2. The controller 26 is connected to a “Start” button 56 by which it is activated, a “Select” button 58 by which it is operated, and an output device 59 on which a result is provided to the user when the device is operated. The output device 59 may be, for example, a visible display, a loudspeaker 24, or both. In the simplest form, the electronic dice 52 may merely display a randomly generated number, which may be used in the game 54 like the result of a roll of an ordinary die. Instead, it may display a specific instruction to the player. In this case, the pocket reader 52 may correspond to the packs of cards included in some conventional board games, which provide penalties, bonuses, or special instructions to players. The number of different instructions available may then be large, if sufficient memory capacity is provided.

The pocket reader 52 is equipped with a smart card reader 34, and is capable of reading a smart card 36. The pocket reader 52 may store information from the smart card 36 in the internal memory 28, or may read information from the memory 42 on the smart card as it is needed. The information relates to the results to be output, and may include the text of instructions or the range of numbers to be displayed, or how frequently each result is to be displayed. As explained above with reference to FIGS. 1 to 3, it is preferred that the processor 40 on the smart card 36 is the principal source of computing power, and controls the operations of the pocket reader 52.

For example, the processor 40 or 26 may initially be programmed to select a number in the range from 1 to 6, with equal probabilities, when the Select button 58 is pressed. It then simply mimics the behavior of a common cubic die, except that it may display an instruction, such as “go forward 2 places” or “miss a turn” read from the memory 28 or 42 instead of, or in addition to, displaying the actual number. However, with enhanced behaviors provided by the smart card 36, the processor 40 or 26 may become capable of choosing a different range of numbers, for example, from 1 to 8, and causing the pocket reader 52 to display new instructions associated with the new numbers. The pocket reader 52 may display different instructions associated with the existing numbers. The pocket reader may become capable of choosing numbers, or instructions, with unequal probabilities. If the pocket reader 52 is configured to provide special instructions, then it may read different special instructions from the smart card 36, and/or may be instructed to display instructions with different frequencies. New behaviors may be downloaded onto the smart card 36 in the same way described above with reference to FIG. 1.

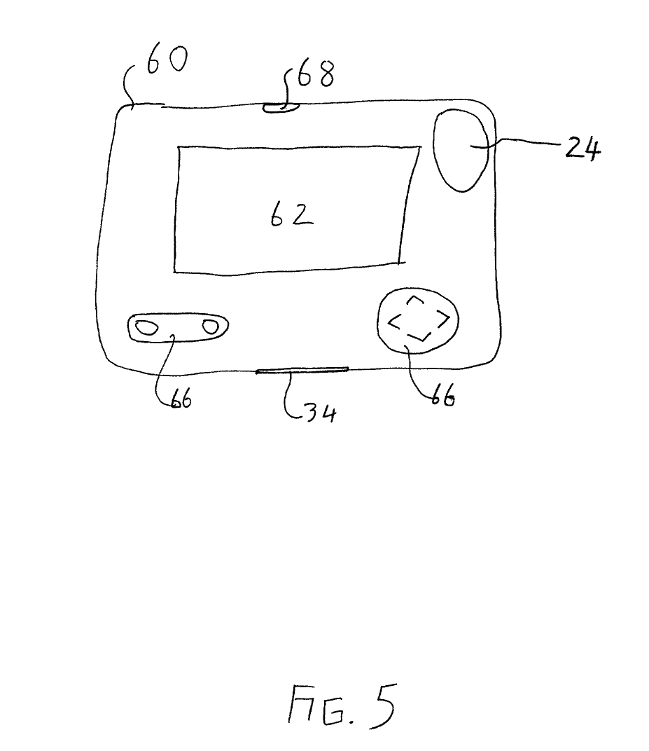

Referring now to FIG. 5, a hand-held game-playing device 60 has a screen 62, a loudspeaker 24, and one or more input controls in the form of buttons 66. The device 60 is programmed to enable a user to play a game, which may be, for example, a role-playing game in which the player can play any one of several distinct characters. The game-playing device 60 presents the player with a scenario including the player's character, the player attempts to guide the character's actions using the input controls 66, and the device 60 responds to the character's actions with changes in the scenario that are typically partly random and partly determinate. Such devices, and such games, are well-known and, in the interests of conciseness, will not be further described here. The device 60 is additionally equipped with a smart card reader 34.

An associated smart card 36 represents a character in the game, such as a bounty hunter, a warrior, a rebel soldier, or whatever is appropriate. The smart card may be initially blank, and the data representing the particular character may be stored in the memory 42 when the user starts playing the game. Instead, the game manufacturer may distribute smart cards 36 pre-programmed to represent specific characters. The hand-held device 60 uses information stored on the card to determine the game to be played by the user. For example, when a bounty hunter card is inserted, the game might be to capture a rebel soldier, while if a rebel soldier card is inserted, the game might be to attack the empire's fortress. In addition, if the game is too long or complex to be reliably completed at a single session, the hand-held device 60 may be programmed to store on the smart card 36, at the end of a session, data relating to the player's status within the game, such as equipment or knowledge that the character has acquired, tasks that have been completed, or the fitness of the character. The player then retains the smart card, and can resume the game where he or she left off, merely by inserting the smart card 36 into any device 60 that has that game available.

Furthermore, two hand-held devices 60 may be provided with communications ports 68 by which they can be linked together. If the users of the two devices have smart cards 36 identifying appropriate characters, the game can then be a one-on-one battle between the players' characters, instead of a game between one player and the game program. In such a two-player game, special weapons, armor, or other attributes may then be transferred from one player's character to the other. Trading or competition can then arise between all players of the particular game for attributes that are in short supply. In that case, data representing the valuable attributes may be transmitted in a secure manner between the two cards, for example, using secret key cryptography, to prevent the more technically ingenious users from interpolating messages that will improperly create or duplicate desirable attributes, or eliminate undesirable ones.

A user can also insert a character card 36 into a reader/writer 44 attached to his or her computer 46, and connect to an associated web site 50. The user can then have the ability to change and/or augment information stored on the card. For instance, if the player's character was injured in a one-on-one battle, the player can go to the web site to “heal” the character. Instead, or in addition, the player may download new weapons or armor. Some downloads may be made conditional on the character's having acquired certain attributes or experience. Downloads may also enable the website operator to introduce new factors into the game, or to give it a level of complexity that the normal memory capacity of the hand-held device 60 would not allow. In this way, the hand-held device 60 becomes a dynamic, changing game based upon interactions with other hand-held devices 60 and the internet.

It will be appreciated that, when the user is negotiating with the website, there is no need for the real identity of the user to be disclosed to the website. The character defined on the smartcard 36 provides a sufficient proxy. Even if the user is making a payment to the website operator, that can be done anonymously using some form of e-cash. If two users engage in one-on-one combat over the web, that can also be arranged anonymously, via the host website 50, with each user being identified only as the character defined on the smartcard 36.

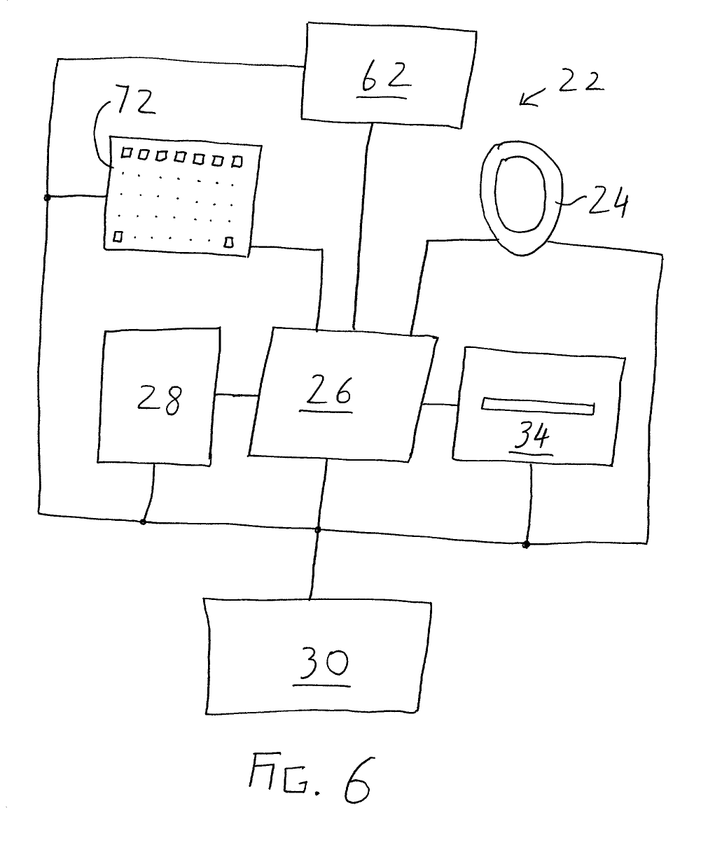

Referring now to FIG. 6, a portable educational device indicated generally by the reference numeral 70 includes a controller 26, which may be in the form of a microprocessor, an output device 22, which may be in the form of a visible display 62 or a loudspeaker 24, an input device, which may be in the form of a keypad 72, memory 28, a reader 34 for a smart card 36, and a power supply 30, which may be in the form of replaceable or rechargeable batteries.

The portable device 70 may be designed to operate with the smart card 36 in the reader 34, in which case the data storage 42 on the smart card may supplement or replace the memory 28. Instead, the portable device 70 may be designed to transfer information from the smart card 36 into the memory 28 within the portable device, and the smart card is then removed from the device and stored separately except when it is actually being used for data transfer. As will be explained below, the reader 34 is also capable of writing certain data onto the smart card 36 under the direction of the controller 26. As has been described for the other embodiments above, if the portable device 70 is operated with the smart card in place, the controller 26 of the portable device 70 may be supplemented or even replaced by a processor 40 on the smart card.

The portable device 70 may be, and preferably is, sufficiently small to be carried in the student's pocket, so that the student can study when, for example, traveling.

The device 70 may be initially supplied to the student with a first set of information stored in the internal memory 28, or with a smart card 36 that has a first set of information stored on it. Instead, the student may be provided with a blank device 70, and may separately procure a smart card 36 that has a first set of information stored on it. Instead, the student may be provided with a blank smart card 36, and may follow the procedure described below to download the first set of information onto the smart card. The “blank” device 70 or smart card 36 may contain identifying information required for the download.

If the portable device 70 has a loudspeaker 24, the information stored may include speech. Such speech may be in the form of recorded sound, preferably in a compressed format such as MP3, or may be in coded form readable by the controller 26 or 40 and from which the controller can generate intelligible speech. If the portable device 70 has a visible display 62, the information stored may include text. It will be appreciated that the use of graphics may be limited by the storage capacity of the smart card 36. However, if the memory 28 contains permanently stored graphic elements, the information on the smart card may include instructions for manipulating those graphic elements.

In use, the educational device 70 presents information and prompts to the student by means of the output device 22, and the student responds by means of the keypad 72. The controller 26 or 40 assesses the accuracy of the student's responses, and may present new information or prompts, or may repeat material, until the student has completed the available material to a particular standard. The controller 26 then asks the student to insert the smart card 36 into the reader 34, if the smart card is not already there, and the controller 26 or 40 records onto the smart card at least information indicating what exercises the student has now completed. The controller 26 may record other information, such as a more detailed analysis of the student's performance, and/or information identifying the type of educational device or individual device 70 or the identity of the student.

The controller 26 or 40 then asks the student to transfer the smart card 36 to the reader/writer 44 connected to the computer 46. A user operating the computer 46 then accesses a supporting website based on the server 50, via the internet or other network 48. If the student is in the middle of a planned course of study, the next module or level of the course may be identified, from the information on the smart card 36 identifying the work just completed, and automatically downloaded. This may be appropriate where the student is a child receiving elementary education. If more detailed information is stored on the smart card, then the next module may be tailored or adjusted to suit the student's past performance. Instead, the user may be permitted to select one of a range of study modules. In that case, it may be appropriate to maintain, either in the memory 28 of the portable device 70, or in the memory 42 of the smart card 36, or at the server 50, a full history of the student's studies and performance. The data required for the selected course, module, or level of study is then downloaded onto the smart card 36.

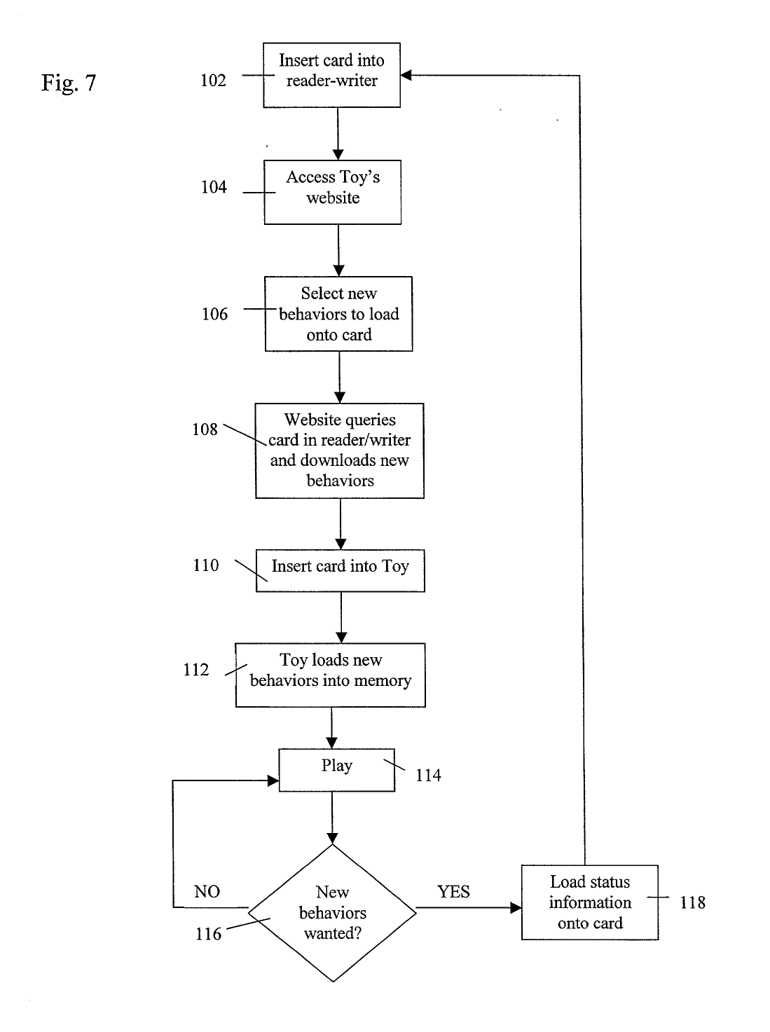

Referring now to FIG. 7, when the user wishes to procure new behaviors in order to enhance or change the functionality of the device 20, 52, 60 or 70, at step 102 the user may insert the smart card 36 into the reader/writer 44 attached to the computer 46. At step 104, the user uses the computer 46 to access a website supported on the server 50, via the internet 48. At step 106, the user may identify the particular game or toy for which new behaviors are desired, and may select particular new behaviors, if there is a choice. Instead, or in addition, at step 108 the website may query the smart card 36 in the reader/writer 44 to obtain information about the particular toy or game. For example, the smart card 36 may contain information identifying the particular toy or game 20, 54, 60, or 70 in order to ensure that the functionality downloaded is appropriate. The user may be allowed to download only specific new behaviors, dependent upon the behaviors previously available, or a check may be made to ensure that the user does not inadvertently download the same behaviors twice. The website then downloads the appropriate new behaviors to the reader/writer 44, which stores them on the smart card 36.

At step 110, the user removes the card 36 from the reader 44, and inserts the smart card into the toy or game 20, 52, 60, or 70. At step 112, the toy or game optionally loads the new behaviors into its internal memory 28. The smart card 36 may then be removed and stored elsewhere. Instead, as explained above, the behaviors may remain stored in the memory 42 on the smart card 36, in which case the smart card should be inserted into the device 20, 52, 60, or 70 in order to use the behaviors. At step 114, the user uses the toy or game with the new functionality.

At step 116, the user decides whether he or she wishes to add new or enhanced behaviors or, in the case of the educational toy 70 and in some circumstances the electronic game-playing device 60, the device itself determines that new behaviors are required and prompts the user to act. If the decision is to obtain new behaviors, at step 118 the user may download onto the smart card 36 information from the memory 28 indicating the user's current state of play. The user then returns to step 102, inserts the smart card 36 into the reader/writer 44, and repeats the process described above.

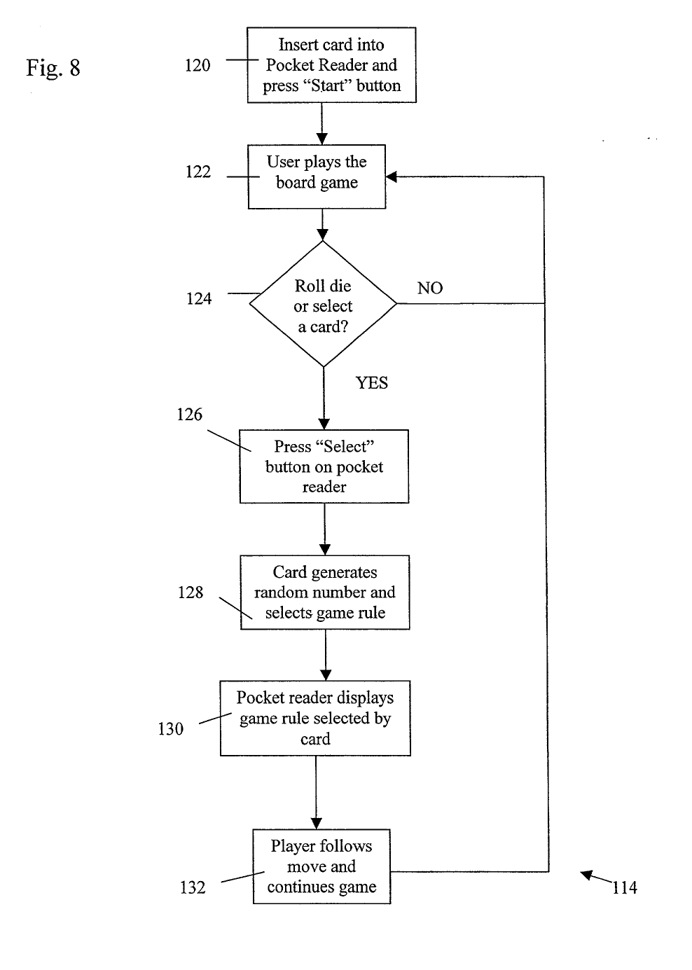

Referring now to FIG. 8, there is shown one form of the step 114 of using the toy or game, which is especially, but not exclusively, suitable for use with the board game 54 and pocket reader 52. At step 120 the user inserts the smart card 36 into the device 52 and presses the Start button 56. The pocket reader 52 reads the smart card 36, and initializes itself for the particular game to be played. At step 122, the user proceeds to play the board game 54. At step 124, it is decided whether a dice roll, card draw, or the like is needed. This may be determined by the rules of the game, or may be at the discretion of the player or players. It may be a frequent event, as in a board game where every move is governed by a dice roll, or it may be a relatively rare event, as in certain games of strategy where randomness is only occasionally introduced.

If a dice roll or card draw is needed, at step 126 the smart card 36 is inserted into the pocket reader 52, if it is not already there, and the user presses the Select button 58. It will be appreciated that if the memory 42 on a single smart card 36 contains all the information needed by the pocket reader 52, it may be inserted into the reader at step 120 and may remain there for the rest of the game. If the information is copied from the card 36 into non-volatile memory 28 within the pocket reader 52, the smart card may be read once and then removed from the pocket reader 52. Instead, if a particular game requires more, or more complicated, behaviors than can be stored on a single smart card 36, one of two or more different smart cards may be selected and inserted into the pocket reader 52 at step 126, according to the particular sort of dice roll or card draw that is needed.

At step 128, the processor 40 on the smart card 36, or the processor 26 of the pocket reader 52, generates a random selection. At step 130, the pocket reader displays on the display 59 a number, an instruction, a bonus or penalty, or the like, corresponding to the selection generated in step 128. At step 132, the player takes the appropriate action indicated by the display 59, and the game continues at step 122.

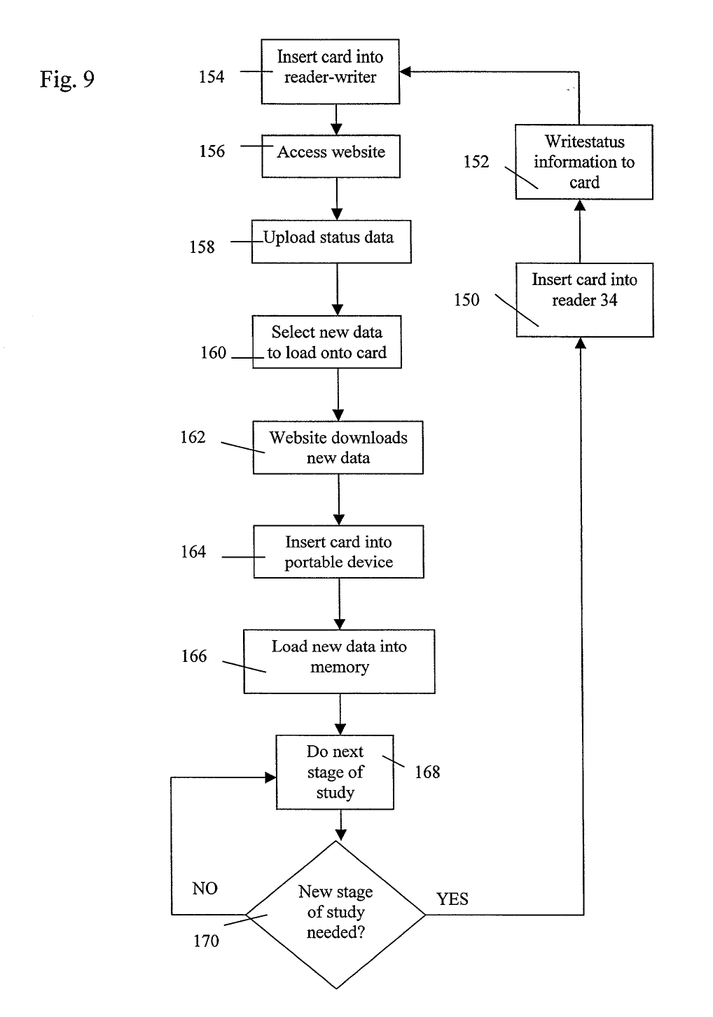

Referring now to FIG. 9, in one embodiment of the method of the invention using the educational toy 70, when the student is ready to begin a new level or module of study, at step 150 the student inserts the smart card 36 into the reader 34 of the portable device 70, if it is not already there. At step 152, the controller 26 or 40 writes the data indicating the student's current level of achievement to the smart card 36, and prompts the student to transfer the smart card to the reader/writer 44. At step 154, the student inserts the card 36 into the reader/writer 44 attached to the computer 46. At step 156, the student uses the computer 46 to access a website supported on the server 50, via the internet 48. At step 158, the status data from the card 36 is uploaded to the website, and the student may supply to the website additional identifying information if necessary. At step 160, the server 50 determines what information to download for the next level or module of study. This may be determined entirely by the student's current status, or the website may offer the student a choice of appropriate modules. At step 162, the website then downloads the appropriate new information to the reader/writer 44, which stores it on the smart card 36.

At step 164, the student removes the smart card 36 from the reader/writer 44, and inserts the smart card into the portable device 70. At step 166, the portable device optionally loads the new behaviors into memory 28. The smart card 36 may then be removed and stored elsewhere. Instead, as explained above, the information may remain stored in the memory 42 on the smart card 36, in which case the smart card should be inserted into the reader 34 in the device 70 in order to use the device. At step 168, the student uses the educational device 70 with the new information for a new stage of study. At step 170, the controller 26 or 40 decides whether the student has satisfactorily completed that stage of study, and new information is required. If the decision is to obtain new information, the controller 26 prompts the student to insert the smart card 36 into the reader 34 in step 102, if it is not already there, and the process described above is repeated.

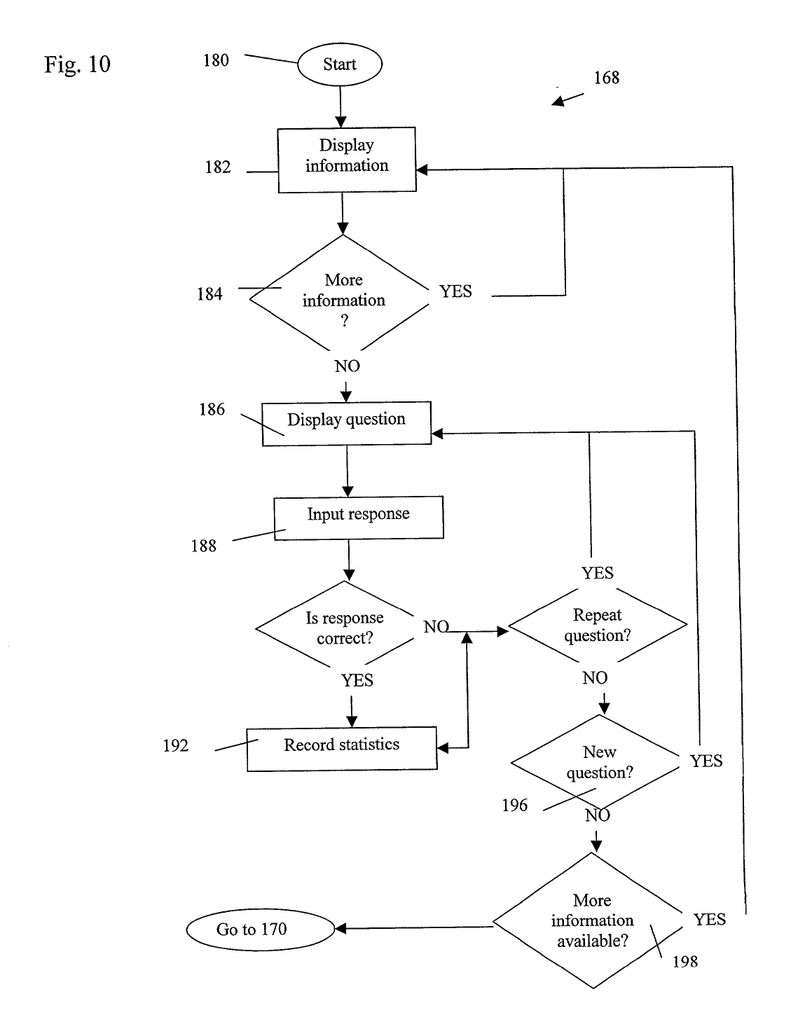

Referring now to FIG. 10, there is shown one form of the step 168 of using the portable educational device 70. At step 180 the student starts the device 70. For simplicity, it will be assumed that the appropriate information is already loaded into the memory 28, and that the device 70 operates under the command of its own controller 26. It will be understood, however, that this description may be applied mutatis mutandis to an educational device 70 using the memory 42 and/or the processor 40 on the smart card 26.. At step 182, the device selects some information from among that stored in the memory 28, and presents that information to the student, using the display 62, loudspeaker 24, or other output device 22. At step 184, the device decides whether to display more information. If so, the device returns to step 182. If not, the device proceeds to step 186, and displays a question or exercise for the student. At step 188, the student inputs a response using the keypad 72. At step 190, the educational device 70 determines whether the response input is correct, and at step 192 records the correct or incorrect response in the user's statistics.

If the question was answered incorrectly, at step 194 the device 70 may decide whether to repeat the question. If the question is to be repeated, the device returns to step 186 with the same question. If the question is not to be repeated, or if the question was correctly answered, the device decides at step 196 whether to ask more questions or require more exercises based on the information already presented. If so, the device returns to step 186 with a new prompt to the student. If several questions or prompts are appropriate, they may be presented in a systematic order, or in a random or quasi-random order. In particular, in a language-teaching program or the like, the device may present repeated prompts based on current and earlier information, in a more or less random sequence. If not, the device checks at step 198 whether there is more information to be presented. If so, the device returns to step 182 with more information. If not, the device 10 returns to step 170, where it decides whether to continue working with the present information or to tell the student to obtain new information.

The present invention may be embodied in other specific forms without departing from the spirit or essential attributes thereof and, accordingly, reference should be made to the appended claims, rather than to the foregoing specification, as indicating the scope of the invention.

For example, although in the interests of clarity the devices 20, 52, 60, and 70 have been depicted as having distinct structural components carrying out distinct functions, it will be understood by the person skilled in the art how those functions may be integrated into fewer components, or distributed among more components.

The invention has been described as embodied in the device 20, 52, 60, or 70 together with the smart card 36 and the smart card reader/writer 44. However, the device 20, 52, 60, or 70 may also be distributed without one or both of the smart card 36 and the reader/writer 44. For example, a user with more than one device 20, 52, 60, or 70 might be able to use the single reader/writer 44 to update all of the devices, and would not then require a separate reader/writer with every device. Further or in the alternative, smart card reader/writers 44 compatible with the smart card 36 may become generally available, in which case it would not be necessary to provide a reader/writer 44 with the device 20, 52, 60, or 70.

Similarly, where a user possesses more than one device 20, 52, or 70 a single smart card 36 could be used to update all of the devices. This will usually require devices 20, 52, or 70 that have sufficient internal memory 28 to store an entire download, and have an internal processor 26, so that the smart card 36 is used only for downloading and is not needed to operate the individual device between downloads. Before downloading new behaviors for a particular toy or game 20 or 54 it might then be necessary to insert the smart card 36 into the relevant device 20 or 52 in order to write onto the smart card any necessary identifying data from that device.

On the other hand, a single portable device, especially a single portable educational device 70 or a single game device 60, might be shared by two or more users, or might be used by a student following two or more unrelated courses of study or a game player playing two or more instances of a game. In that case, the internal memory 28 of the device 60 or 70 may contain separate files for the status of the separate students, players, courses, or games. However, it may be preferred to load the information for each course from a smart card 36 at the beginning of each session of study, in order to reduce the demands on the internal memory capacity, or to rely entirely on the memory 42 in the smart card. Instead, it may be preferred to clear the internal memory of the device 60 or 70 entirely between sessions, in which case the status information must be read from and written to the smart card 36 at each session. It will be appreciated that these latter approaches will require a separate smart card for each student, course of study, player, or character, as was discussed above for the case where the smart cards 36 are dedicated to a particular character in a role-playing game.

In the interests of clarity, the interface unit 44 has been referred to as a “reader/writer” and the component 34 has been referred to as a “reader.” However, a person skilled in the art will understand from the foregoing specification that for certain of the embodiments described the “reader” 34 must also be capable of writing data to the smart card 36. Also, for certain embodiments the interface unit 44 could be a writer that is not capable of reading the card. However, this is not preferred because, even where the interface unit 44 does not need to read data from the card 36, it is preferably capable of reading and verifying what it has itself just written. It will be further understood that the actions of “reading” and “writing” may include receiving data from the card and supplying data to the card, which data is actually read from or written to the memory 42 under the control of the processor 40 embedded on the card.

The reader/writer 44 has been described as being plugged into a data port on the computer 46. However, other means of connecting the reader/writer 44 to the network 48 are well known. For example, the reader/writer 44 may be designed to install into a drive bay, or may be equipped with a network card to connect directly to a local area network that is connected to the internet.

In the interests of conciseness and clarity, certain of the apparatus described above have been described as electronic. However, the choice of particular technology is not essential, and the invention may equally be applied using other technologies that are being developed, or that may become available in the future.

What is claimed is:

1. A recreational device comprising:
a smart card;
a smart-card interface unit adapted to be connected to a network, and to record on said smart card information received over said network; and
a portable device comprising:
an input device operable by a user;
an output device adapted to produce outputs perceptible by the user;
a controller adapted to cause the signaling unit to produce a selected one of a plurality of outputs in response to operation of the control; and
a smart-card reader adapted to receive a smart card and to read information determining said outputs from said smart card.

2. A recreational device according to claim 1, wherein the controller is adapted to select one of said plurality of responses substantially at random in response to operation of said input device.

3. A recreational device according to claim 2, wherein said portable device is adapted to output a random number or instruction for use in playing a game when said input device is operated.

4. A recreational device according to claim 3, further comprising a game to be played in accordance with such random numbers or instructions.

5. A recreational device according to claim 1, wherein said portable device further comprises a sound generator, and is arranged to produce said output in the form of speech through said sound generator.

6. A recreational device according to claim 5, wherein said portable device is a doll, which is adapted to produce speech when manipulated by a user, and which is adapted to read data files containing such speech from said smart card.

7. A recreational device according to claim 1, wherein said portable device further comprises a visible display, and is arranged to produce said output in the form of text on said display.

8. A recreational device according to claim 1, wherein said portable device further comprises a memory, and is arranged to transfer information from said smart card to said memory.

9. A recreational device according to claim 1, wherein said portable device is arranged to read information from said smart card when a response is selected and to use that information to generate the selected response.

10. A recreational device according to claim 1, wherein said portable device is adapted to record information on said smart card.

11. A recreational device according to claim 10, wherein said portable device is adapted to record on said smart card information identifying the device.

12. A recreational device according to claim 1, wherein said controller is adapted to cause said output device to display information and prompts to the user using stored data and to receive inputs from the user in response to such prompts, and wherein said controller and said smart card are adapted to record on said smart card status information relating to such responses.

13. A recreational device according to claim 12, wherein said input device further comprises a keypad.

14. A recreational device according to claim 12, wherein said controller is adapted to determine when available information and prompts have been sufficiently used, to record current status information on said smart card, and to prompt a user to procure fresh data by means of said smart card, said smart-card writer, and said network.

15. A recreational device according to claim 1, wherein said portable device includes said smart card when received in said smart card reader, and said controller comprises a processor on said smart card.

16. A method of using a recreational device, comprising the steps of:
a) providing a portable device capable of displaying various behaviors using stored data, and equipped with a smart card reader capable of reading such data from a smart card;
b) providing a smart card capable of storing and transmitting electronic data;
c) providing a server carrying such data and accessible over a network;
d) providing a smart card reader/writer capable of writing said data onto said smart card;
e) establishing a communication link over said network between said reader/writer and said smart card;
f) selecting data for transmission from said server to said smart card;
g) reading said selected data from said server;
h) writing said selected data to said smart card using said smart card reader/writer;
i) removing said smart card from said reader/writer and inserting it into said reader of said portable device;
j) reading said selected data from said smart card; and
k) operating said portable device to display said behaviors using said selected data.

17. A method according to claim 16, wherein said portable device comprises a memory capable of storing said data, said step of reading said selected data from said smart card comprises copying said data into said memory, and said step of operating said portable device comprises using data from said memory.

18. A method according to claim 16, wherein said step of operating said portable device comprises using data read directly from said smart card.

19. A method according to claim 16 of operating a doll, wherein said selected data comprises a repertoire of recorded speech, and said behaviors comprise uttering a speech from said repertoire.

20. A method according to claim 16 of playing a game, wherein said data comprise instructions or items of information for playing said game, and said behavior comprises outputting a randomly selected one of said instructions or items of information.

21. A method according to claim 16 of playing a game, wherein said data comprise information for playing said game, and said behavior comprises outputting items of information indicating changes in the status of the game in response to the user inputs.

22. A method according to claim 16, comprising the steps of:
presenting information and prompts to a user by means of said portable device using said stored data;
accepting inputs from a user responsive to such prompts by means of said portable device, and recording status information related to said responsive inputs;
determining from said status information by means of said portable device when new stored data is to be procured for said portable device;
transmitting from said smart card to said server status data previously written to said smart card by said portable device;
selecting data for transmission from said server to said smart card in response to said transmitted status data;
transmitting said selected data from said server to said smart card; and
operating said portable device using said selected data.

23. A method according to claim 22 of education, wherein said step of determining when new stored data is to be procured comprises assessing from said responsive inputs when said user has sufficiently learned information contained in said stored data.

24. A method according to claim 16, further comprising the step of writing information from said portable device to said smart card before said step of establishing a communication link, and wherein said step of selecting data comprises transmitting from said smart card to said server the information written by said portable device, and wherein in said step of selecting data the selection is restricted to data consistent with said information.

25. A portable recreational device comprising:
a control operable by a user;
a signaling unit adapted to produce outputs perceptible by the user;
a smart-card reader adapted to receive a smart card and to read information from said smart card; and
a controller responsive to operation of the control to cause the signaling unit to produce a substantially randomly selected one of a plurality of outputs using the said information.

26. A portable recreational device according to claim 25, wherein said portable device is adapted to output a random number or instruction for use in playing a game when said control is operated.

27. A portable recreational device according to claim 25, further comprising a sound generator, and arranged to produce said output in the form of speech through said sound generator.

28. A portable recreational device according to claim 27, which is a doll, which is adapted to produce speech when manipulated by a user, and which is adapted to read data files containing such speech from said smart card.

29. A portable recreational device according to claim 25, which further comprises a visible display, and is arranged to produce said output in the form of text on said display.

30. A portable recreational device according to claim 25, which further comprises a memory, and is arranged to transfer information from said smart card to said memory.

31. A portable recreational device according to claim 25, which is arranged to read information from said smart card when a response is selected and to use that information to generate the selected response.

32. A portable recreational device according to claim 18, which is adapted to record on said smart card information identifying itself.

33. A method of education, comprising the steps of:
a) providing a portable device capable of presenting information using stored data and accepting inputs from a user, and equipped with a smart card reader capable of reading such data from a smart card and of writing data to a smart card;
b) presenting information and prompts to a user by means of said portable device using said stored data;
c) accepting inputs from a user responsive to such prompts by means of said portable device, and recording status information related to said responsive inputs;
d) determining from said status information by means of said portable device when new stored data is to be procured for said portable device;
e) providing a smart card capable of storing and transmitting electronic data;
f) providing a server carrying such data and accessible over a network;
g) providing a smart card reader/writer capable of writing said data onto said smart card;
h) establishing a communication link over said network between said reader/writer and said smart card;
i) transmitting from said smart card to said server status data previously written to said smart card by said portable device;
j) selecting data for transmission from said server to said smart card in response to said transmitted status data;
k) transmitting said selected data from said server to said smart card;
l) removing said smart card from said reader/writer and inserting it into said reader of said portable device;
m) reading said selected data from said smart card; and
n) operating said portable device using said selected data.

34. A method according to claim 33, wherein said portable device comprises a memory all capable of storing said data, said step of reading said selected data from said smart card comprises copying said data into said memory, and said step of operating said portable device comprises using data from said memory.

35. A method according to claim 33, wherein said step of operating said portable device comprises using data read directly from said smart card.

36. A method according to claim 33, wherein said portable device comprises a memory capable of storing said status information and said step of recording status information comprises storing the status information into said memory, and further comprising a step of writing status information to said smart card using the status information previously stored in said memory.

37. A method according to claim 36, wherein the status information written to the smart card contains less information than the status information stored into the memory of the portable device.

38. A method according to claim 33, wherein said step of recording status information comprises writing said status information to said smart card.

39. A method according to claim 38, wherein said step of transmitting status data from said smart card to said server comprises transmitting less information than has been stored on said smart card.

40. A method according to claim 33, wherein the prompts are adapted to test the user's grasp of the information presented, and the status information indicates the accuracy of the user's responses.

41. A method according to claim 33, wherein the prompts are adapted to encourage the user to practice use of the information presented, and the status information indicates the extent of practice by the user.

42. A recreational device comprising:
a smart card;
a smart-card writer adapted to be connected to a network, and to record on said smart card information received over said network; and
a portable device comprising:
an output device adapted to produce outputs perceptible by the user;
an input device adapted to receive input from the user;
a controller adapted to cause the signaling unit to display information and prompts to the user using stored data, to receive inputs from the user in responsive to such prompts, and to record status information relating to such responses; and
a smart-card reader adapted to receive a smart card, to read from said smart card, and to write status information to said smart card.

43. A device according to claim 42, wherein said input device further comprises a keypad.

44. A device according to claim 42, wherein said portable device further comprises a sound generator, and is adapted to produce said output in the form of speech through said sound generator.

45. A device according to claim 42, wherein said portable device further comprises a visible display.

46. A device according to claim 42, wherein said portable device is adapted to produce said output in the form of text on said display.

47. A device according to claim 42, wherein said portable device is adapted to produce said output in the form of images on said display.

48. A device according to claim 42, wherein said portable device further comprises a memory, and is adapted to transfer said data from said smart card to said memory.

49. A device according to claim 10, wherein said portable device is adapted to read information from said smart card when said information is required to generate an output or to assess an input.

50. A device according to claim 42, wherein said portable device is adapted to determine when available information and prompts have been sufficiently used, to record current status information on said smart card, and to prompt a user to procure fresh data by means of said smart card, said smart-card writer, and said network.

51. A portable educational device comprising:
an output device adapted to produce outputs perceptible by the user;
an input device adapted to receive input from the user;
a controller adapted to cause the output device to display information and prompts to the user using stored data, to receive inputs from the user in responsive to such prompts, and to record status information relating to such responses; and
a smart-card reader adapted to receive a smart card, to read from said smart card, and to write status information to said smart card.

52. A portable educational device according to claim 51, wherein said input device further comprises a keypad.

53. A portable educational device according to claim 51, which further comprises a sound generator, and is adapted to produce said output in the form of speech through said sound generator.

54. A portable educational device according to claim 51, which further comprises a visible display, and is adapted to produce said output in the form of text on said display.

55. A portable educational device according to claim 51, which further comprises a memory, and is adapted to transfer said data from said smart card to said memory.

56. A portable educational device according to claim 51, which is adapted to read information from said smart card when said information is required to generate an output or to assess an input.

57. A portable educational device according to claim 17, which is adapted to determine when available information and prompts have been sufficiently used, to record current status information on said smart card, and to prompt a user to procure fresh data by means of said smart card.

58. A portable game-playing device comprising:
an output device adapted to produce outputs perceptible by the user;
an input device adapted to receive input from the user;
a controller adapted to cause the output device to display a current state of a game to the user using stored data, to receive inputs from the user in responsive to the displayed state of the game, to update the state of the game in response to such inputs, and to record status information relating to such responses; and
a smart-card reader adapted to receive a smart card, to read from said smart card, and to write status information to said smart card.

59. A portable game-playing device according to claim 58, wherein said input device further comprises a keypad.

60. A portable game-playing device according to claim 59, which further comprises a sound generator, and is adapted to produce audible output through said sound generator.

61. A portable game-playing device according to claim 59, which further comprises a visible display, and is adapted to produce said output in the form of images on said display.

62. A portable game-playing device according to claim 59, which further comprises a memory, and is adapted to transfer said data from said smart card to said memory.

63. A portable game-playing device according to claim 59, which is adapted to read information from said smart card when said information is required to generate an output or to assess an input.

64. A portable game-playing device according to claim 59, which is adapted to read from and write to said smart card information relevant to the status of the individual player, and to read from a separate source information common to numerous instances of the game.

65. A portable game-playing device according to claim 59, which is equipped with a communications port and is capable of communicating with another similar device to permit users of the two devices to play a competitive game against each other.

66. A portable game-playing device according to claim 65, which is capable of transferring data between a smart card in the smart-card reader of the said device and a smart card in a smart card reader of another similar device with which the said device is in communication.
